(19) United States
(12) Patent Application Publication
(10) Pub. No.: US 2018/0045375 A1
(43) Pub. Date: Feb. 15, 2018

(54) SMART SOLENOID CONTROL SYSTEM

(71) Applicant: HONEYWELL INTERNATIONAL INC., Morris Plains, NJ (US)

(72) Inventors: Renukaprasad N, Bangalore (IN); Deepak Pitambar Mahajan, Bangalore (IN); Prasad Devara, Bangalore (IN); Siva Bavisetti, Bangalore (IN)

(73) Assignee: HONEYWELL INTERNATIONAL INC., Morris Plains, NJ (US)

(21) Appl. No.: 15/233,292

(22) Filed: Aug. 10, 2016

(51) Int. Cl. F17D 3/01; F16K 37/00; G05D 7/06

(52) U.S. Cl. CPC F17D 3/01; G05D 7/0641; F16K 37/0041; F16K 37/005

(57) ABSTRACT

A smart solenoid control system for controlling flow of fluid in a conduit includes a solenoid, a plurality of fluid sensors, a plurality of solenoid sensors, a display device, a communication module, and a control. Each fluid sensor senses a parameter associated with the fluid in the conduit. Each solenoid sensor senses a parameter associated with the solenoid. The display device is configured to render images. The communication module is configured to transmit received data to a remote station or handheld device. The control is coupled to receive signals from the fluid sensor signals and the solenoid sensors and determines whether the solenoid should be in a first or second position, supplies drive current to the solenoid to cause the solenoid to move to the desired position, selectively commands the display device to render images, and supplies the data to the communication module for transmission.

### TECHNICAL FIELD

The present invention generally relates to solenoid control valves, and more particularly relates to a smart solenoid control system, which may be used to control and monitor solenoid-operated devices, such as valves.

### BACKGROUND

Various fluids may be transported via pipelines. For example, various fuels, such as oil, natural gas and biofuels, and various other fluids, such as water, sewage, and slurry, may be transported via pipelines. Indeed, according to some estimates, worldwide there is presently almost 3.5 million kilometers of pipeline in 120 countries.

A fluid pipeline system may include, for example, one or more pumps, pressure regulators, gate valves, solenoid-operated shut-off valves, solenoid-operated flow valves, and various fluid sensors (e.g., temperature, pressure, flow). Typically, these valves and sensors are disposed at a substation along the pipeline, and personnel at the substation monitor, either continuously or periodically, various fluid and solenoid-related parameters. This requires constant effort from the substation personnel, and increases the likelihood of human errors. Moreover, in the highly unlikely event of a fault, there could be a time delay between fault occurrence, fault recognition, fault isolation (e.g., shut one or more valves), and ultimate restoration (e.g., re-open the shut valves) by the substation personnel.

In view of the foregoing, there is need for the capability to remotely monitor fluid and system parameters, such as fluid pressure, fluid flow, fluid temperature, solenoid temperature, solenoid position, and to automatically implement various self-tests, fault detection, fault alarm, and fault isolation/prevention procedures. The present invention addresses at least these needs.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a smart solenoid control system for controlling flow of fluid in a conduit includes a solenoid, a plurality of fluid sensors, a plurality of solenoid sensors, a display device, a communication module, and a control. The solenoid is coupled to receive a drive current and is configured, in response thereto, to move between a first position and a second position. Each fluid sensor is configured to sense a parameter associated with the fluid in the conduit and supply a fluid sensor signal representative thereof. Each solenoid sensor is configured to sense a parameter associated with the solenoid and supply a solenoid sensor signal representative thereof. The display device is coupled to receive display commands and is configured, upon receipt thereof, to render images. The communication module is coupled to receive data and is configured, upon receipt thereof, to transmit the received data to a remote station or handheld device. The control is coupled to receive the fluid sensor signals and the solenoid sensor signals and is configured, upon receipt thereof, to: determine whether the solenoid should be in the first or second position, based on the determination, selectively supply the drive current to the solenoid to cause the solenoid to move to the first or second position, at least selectively command the display device to render images representative of one or more of the parameters associated with the fluid and the parameters associated with the solenoid, and supply the data to the communication module for transmission thereby.

In another embodiment, a smart solenoid control system for controlling flow of fluid in a conduit includes a solenoid, a plurality of fluid sensors, a plurality of solenoid sensors, a display device, a communication module, and a control. The solenoid is coupled to receive a drive current and is configured, in response thereto, to move between a first position and a second position. Each fluid sensor is configured to sense a parameter associated with the fluid in the conduit and supply a fluid sensor signal representative thereof. Each solenoid sensor is configured to sense a parameter associated with the solenoid and supply a solenoid sensor signal representative thereof. The display device is coupled to receive display commands and is configured, upon receipt thereof, to render images. The communication module is configured to receive solenoid control system settings from a remote station or handheld device and, upon receipt thereof, to supply the solenoid control system settings. The control is coupled to receive the fluid sensor signals, the solenoid sensor signals, and the solenoid control system settings. The control is configured, upon receipt of these signals to: determine whether the solenoid should be in the first or second position, based on the determination, selectively supply the drive current to the solenoid to cause the solenoid to move to the first or second position, at least selectively command the display device to render images representative of one or more of the parameters associated with the fluid and the parameters associated with the solenoid, implement built-in self-tests of one or more of itself, the solenoid, the fluid sensors, the solenoid sensors, the display device, and the communication module, and prognosticate end-of-life capabilities of one or more of itself, the solenoid, the fluid sensors, the solenoid sensors, the display device, and the communication module.

In yet another embodiment, a smart solenoid control system for controlling flow of fluid in a conduit includes an explosion-proof enclosure, a solenoid, a plurality of fluid sensors, a plurality of solenoid sensors, a touchscreen display device, a communication module, and a control. The solenoid is disposed within the explosion-proof enclosure, is solenoid coupled to receive a drive current, and is configured, in response thereto, to move between a first position and a second position. The fluid sensors are disposed within the explosion-proof enclosure. Each fluid sensor is configured to sense a parameter associated with the fluid in the conduit and supply a fluid sensor signal representative thereof. The solenoid sensors are disposed within the explosion-proof enclosure. Each solenoid sensor is configured to sense a parameter associated with the solenoid and supply a solenoid sensor signal representative thereof. The touchscreen display device is disposed within the explosion-proof enclosure. The touchscreen display device is coupled to receive display commands and is configured, upon receipt thereof, to render images. The communication module is disposed within the explosion-proof enclosure. The communication module is coupled to receive data and is configured, upon receipt thereof, to transmit the received data to a remote station or handheld device. The control is disposed within the explosion-proof enclosure. The control is coupled to receive the fluid sensor signals and the solenoid sensor signals and is configured, upon receipt thereof, to: determine whether the solenoid should be in the first or second position, based on the determination, selectively supply the drive current to the solenoid to cause the solenoid to move to the first or second position, at least selectively command the display device to render images representative of one or more of the parameters associated with the fluid and the parameters associated with the solenoid, and supply the data to the communication module for transmission thereby.

Furthermore, other desirable features and characteristics of the smart solenoid control system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a schematic diagram of a portion of one embodiment of a fluid pipeline system 100;

FIGS. 2 and 3 depict cross section and perspective views, respectively, of one embodiment of a physical implementation of a smart solenoid control system that may be implemented in the pipeline of FIG. 1;

FIG. 4 depicts a schematic diagram of the smart solenoid control system depicted in FIGS. 2 and 3;

FIG. 5 depicts, in flowchart form, one example of a built-in self-test process that the smart solenoid control system may implement; and

FIG. 6 depicts, in flowchart form, one example of an end-of-life prognostication process that the smart solenoid control system may implement.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

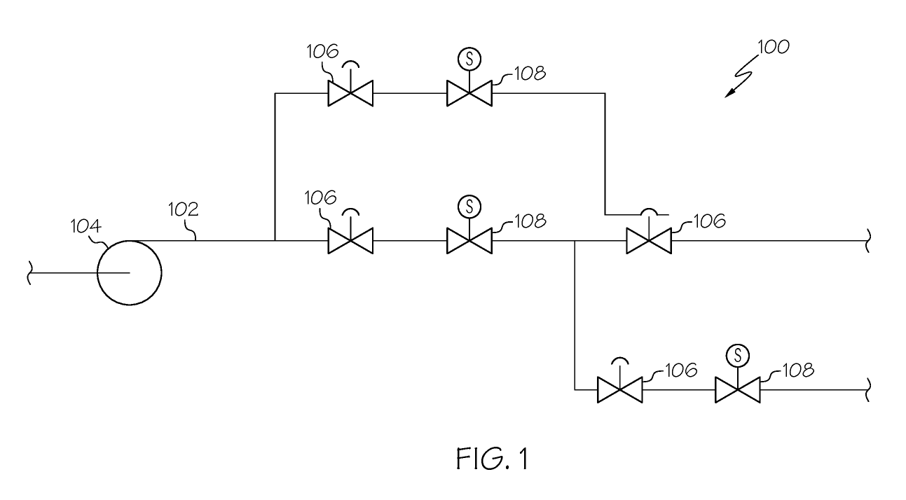

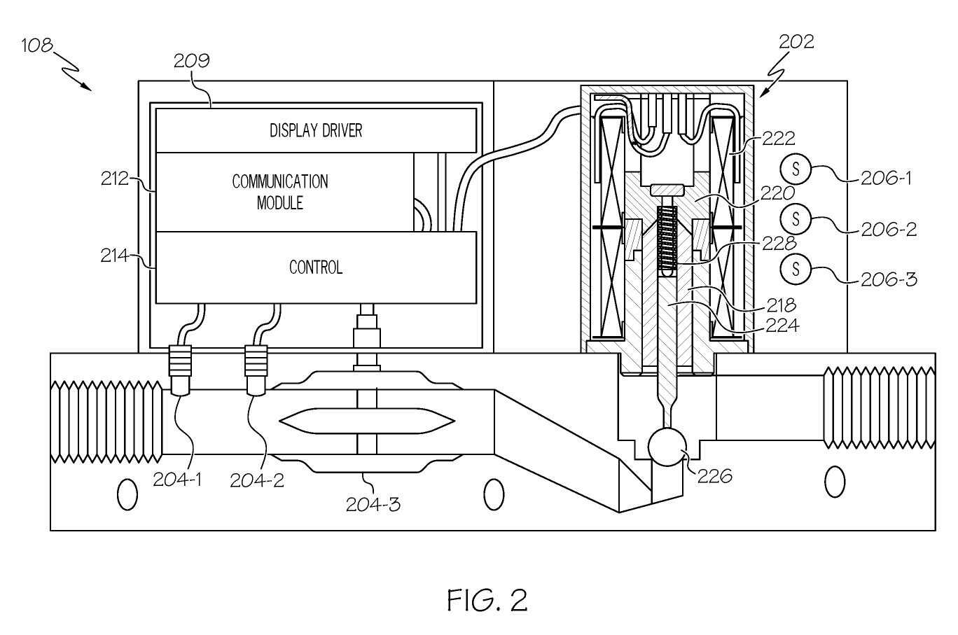

Referring to FIG. 1, a schematic diagram of a portion of one embodiment of a fluid pipeline system 100 is depicted. The portion of the pipeline system 100 that is depicted includes conduit 102, a pump 104, a plurality of regulating valves 106, and a plurality of solenoid-operated valves 108. The conduit 102, as is generally known, may be made of any one of numerous types of steel or plastic, and may include various branch lines, in addition to the main supply line. The pump 104 and regulating valves 106, if included, are conventional and implemented using generally well-known components. Thus, detailed descriptions of these components will not be provided. The solenoid-operated valves 108 are each implemented as a smart solenoid control system 108 for controlling the flow of fluid within the conduit 102. One embodiment of a smart solenoid control system 108 is depicted in FIG. 2-4, and will now be described.

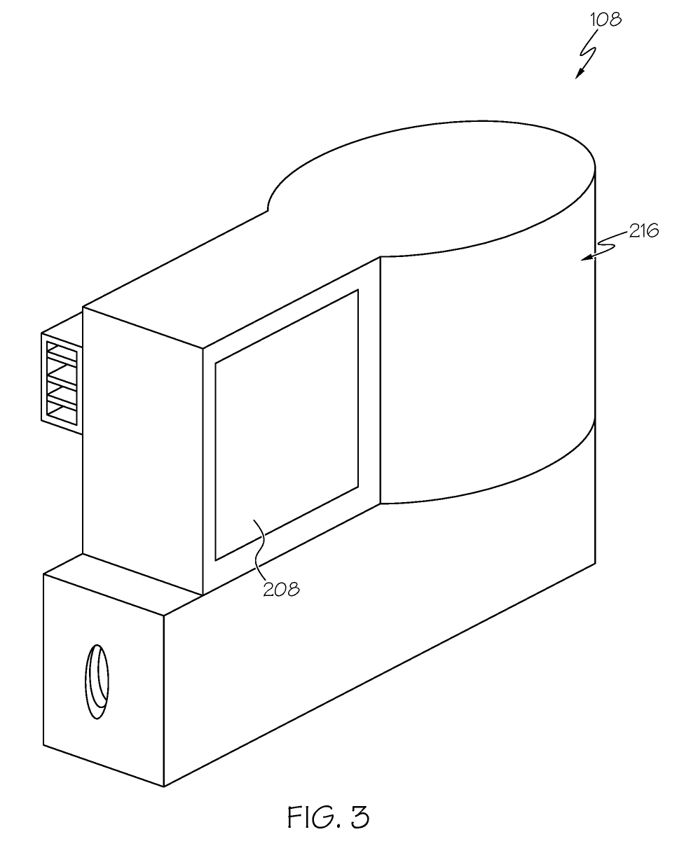

Referring first to FIGS. 2 and 3, it is seen that each of the smart solenoid control systems 108 includes a solenoid 202, a plurality of fluid sensors 204, a plurality of solenoid sensors 206, a display device 208 (see FIG. 3), a communication module 212, and a control 214, all of which are preferably housed within an explosion-proof enclosure 216. As FIGS. 2 and 3 depict, a portion of the enclosure 216 may form part of, and may thus be installed directly into, the conduit 102.

The explosion-proof enclosure 216, as noted houses at least the various electronic and electrical devices and systems that comprise the smart solenoid control system 108. The explosion-proof enclosure 216 is configured to provide a wiring connection via, for example, a detachable connector pair or for a suitable wiring harness. The connector pair can be variously configured. Preferably, however, it is configured as a suitable industrial grade polymer connector or military grade circular connector. The explosion-proof enclosure 216 may be manufactured of metallic or non-metallic composite material, using any one of numerous known manufacturing processes such as, but not limited to, forging, 3D printing, machining, molding.

The solenoid 202 is coupled to receive a drive current and is configured, in response thereto, to move between a first position, which is the position depicted in FIG. 2, and a second position. It will be appreciated that the drive current supplied to the solenoid 202 is representative of, for example, a desired fluid flow through the conduit, which may be based on a command received from a remote station and/or a handheld device (both of which are described further below). The solenoid 202 may be variously configured to implement this functionality, but in the depicted embodiment it includes, among various other components, an armature 218, a stop 220, and a coil 222. The armature 218, which preferably comprises a material having a relatively high magnetic permeability, is coupled, via an actuation rod 224, to a valve element 226. In the depicted embodiment, the valve element 226 is a ball-type valve, but in other embodiments it could be any one of numerous other types of valve elements.

Regardless of the type of valve element 226 that is used, the armature 218 is axially movable within the enclosure 216 between the first position and the second position. More specifically, in the depicted embodiment, the solenoid 202 is configured as a pull-type solenoid. Thus, the armature 218, in response to the coil 222 being energized with the drive current, moves from the first position to the second position, to thereby move the valve element 226 from a closed position (FIG. 2) to an open position. When the coil 222 is subsequently de-energized, the armature 218 moves, with the aid of a spring 228, from the second position to the first position, to thereby move the valve element 226 from the open position to the closed position. It will be appreciated that the spring may be variously implemented. In the depicted embodiment, the spring 228 is implemented using a helical compression spring. In other embodiments, the spring 228 may be a helical expansion spring, a Belleville spring, or spring washers, just to name a few non-limiting examples. It will additionally be appreciated that in other embodiments, the solenoid 102 could be configured as a push-type solenoid.

Each of the fluid sensors 204 is configured to sense a parameter associated with the fluid in the conduit 102, and to supply a fluid sensor signal representative of the parameter to the control 214. Although the number and type of fluid sensors 204 may vary, in the depicted embodiment, each smart solenoid control system 108 includes a fluid pressure sensor 204-1, a fluid temperature sensor 204-2, and a fluid flow sensor 204-3. The fluid pressure sensor 204-1, as may be appreciated, is configured to sense the pressure of the fluid in the conduit 102, and supply fluid pressure signals representative thereof. The fluid pressure sensor 204-1 may be implemented using any one of numerous types of pressure sensors. The fluid temperature sensor 204-2 is configured to sense the temperature of the fluid in the conduit 102, and supply fluid temperature signals representative thereof. The fluid temperature sensor 204-2 may be implemented using any one of numerous types of temperature sensors. The fluid flow sensor 204-3 is configured to sense the flowrate of the fluid in the conduit 102, and supply fluid flowrate signals representative thereof. The fluid flow sensor 204-3 may be implemented using any one of numerous types of flow sensors.

Each of the solenoid sensors 206 is configured to sense a parameter associated with the solenoid 202, and to supply a solenoid sensor signal representative of the parameter to the control 214. Although the number and type of solenoid sensors 206 may vary, in the depicted embodiment, each smart solenoid control system 108 includes a solenoid current sensor 206-1, a solenoid position sensor 206-2, and a solenoid temperature sensor 206-3. The solenoid current sensor 206-1 is configured to sense the current in the solenoid coil 222, and supply current signals representative thereof. The solenoid current sensor 206-1 may be implemented using any one of numerous types of current sensors, and may be used to measure, for example, solenoid pull-in current, solenoid drop-out current, and solenoid hold current. The solenoid position sensor 206-2 is configured to sense the position of the armature 218, and supply position signals representative thereof. The solenoid position sensor 206-2 may be implemented using any one of numerous types of position sensors. The solenoid temperature sensor 206-3 is configured to sense the temperature of the solenoid 202, and supply solenoid temperature signals representative thereof. The solenoid temperature sensor 206-3 may be implemented using any one of numerous types of flow sensors, and may be used to measure one or both of solenoid coil temperature and solenoid body temperature.

The display device 208 is coupled to receive display commands and is configured, upon receipt of the display commands, to render images. The display device 208 may be variously implemented, but in the depicted embodiment it is implemented using a touchscreen display that is driven by a suitable display driver 209. It will be appreciated that the display device 208 may be commanded to display various types of information. Some examples of the types of information that the display device 208 may be commanded to display includes, but is not limited to, one or more of the sensed fluid parameters, one or more of the sensed solenoid parameters, various alerts, fault data, and various tests being conducted, just to name a few.

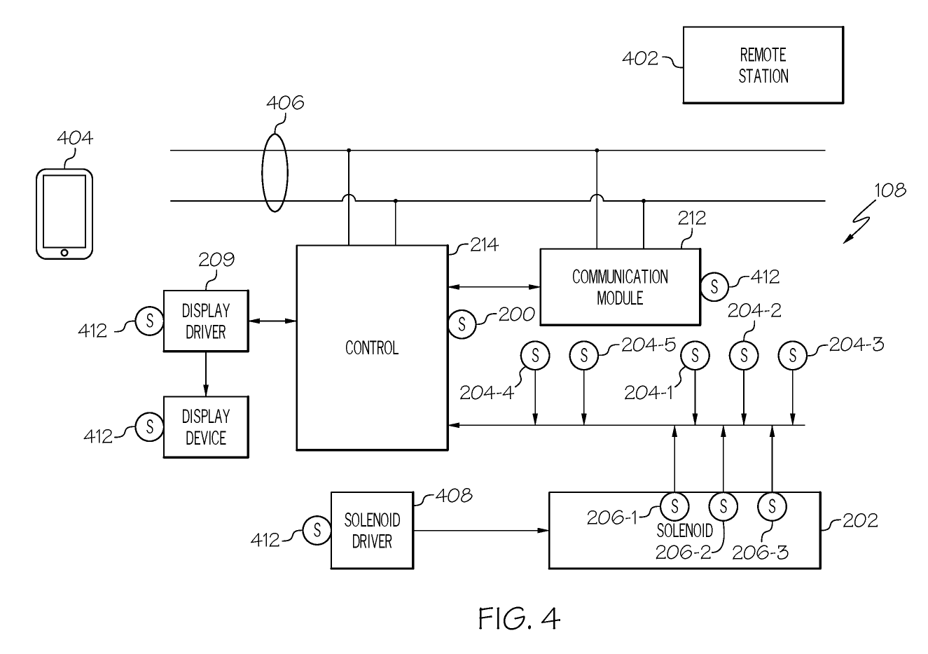

The communication module 212 is coupled to receive various types of data and is configured to transmit the received data to a remote station 402 and/or a handheld device (e.g., tablet, smartphone, custom device, etc.) 404 (see FIG. 4). It will be appreciated that the data may be transmitted over a wired connection or a wireless connection. If transmitted via a wired connection, the data may be transmitted using controller area network (CAN) protocol, power line communication (PLC) protocol (via power supply bus 406 (FIG. 4)), or any one of numerous other communication protocols. If transmitted wirelessly, the data may be transmitted using any one of numerous wireless communication protocols, such as Bluetooth® or various Wi-Fi communications protocols, and may, if needed or desired, be encrypted. It will additionally be appreciated that the handheld device 404 and communication module 212 may communicate wirelessly or via a suitable hardware connection, such as a USB port. If the handheld device 404 is implemented using a smartphone, tablet, or other similar device, it may implement a downloadable application (i.e., an “app”) to, for example, monitor solenoid parameters during an in-line inspection as well as to provide pop ups in case one or more parameters values exceeds a threshold value.

It should be noted that the communication module 212 may also be configured to implement numerous other functions. These other functions will be described further below. Before doing so, however, a description of the control 214 will be provided.

The control 214, as shown more clearly in FIG. 4, is in operable communication with each of the fluid sensors 204, with each of the solenoid sensors 206, with the display driver 209, and with the communication module 212. The control 214 is coupled to receive the fluid sensor signals from each of the fluid sensors 204, and the solenoid sensor signals from each of the solenoid sensors 206. The control 214 is configured, upon receipt of these sensor signals, to implement numerous functions. These functions include determining whether the armature 218, and thus the valve element 226, should be in the first (closed) or second (open) position and, based on this determination, selectively supplying the drive current to the solenoid 202, and more specifically to a solenoid driver 408, to cause the solenoid 202 to move to the first or second position, to thereby move the valve element 226 to the closed or open position.

Before proceeding further, it is noted that the solenoid driver 408 may be variously configured and implemented. In the depicted embodiment, however, the solenoid driver is configured as a pulse width modulation (PWM) current driver. Such drivers, as is generally known, regulate current with a well-controlled waveform to ensure activation and reduce power consumption. Preferably, the solenoid driver 408 is configured to rapidly ramp up the solenoid drive current to ensure quick movement of the armature 218 to the second position. Thereafter, the solenoid drive current is set at a constant peak value, and then reduced to a lower hold magnitude to reduce power and thermal load.

Returning to a description of the functions that the control 214 implements, it is noted that the control 214 is additionally configured, upon receipt of the fluid and solenoid sensor signals, to at least selectively command the display device 208 to render images representative of one or more of the parameters associated with the fluid and the parameters associated with the solenoid. As noted above, in addition to the fluid-related and solenoid-related parameters, the control 214 may also command the display device 208 to display, for example, various alerts, fault data, and various tests being conducted, just to name a few. The control 214 is also configured, upon receipt of the fluid and solenoid sensor signals, to supply the data to the communication module 212 for transmission thereby to the remote station 402 and/or handheld device 404.

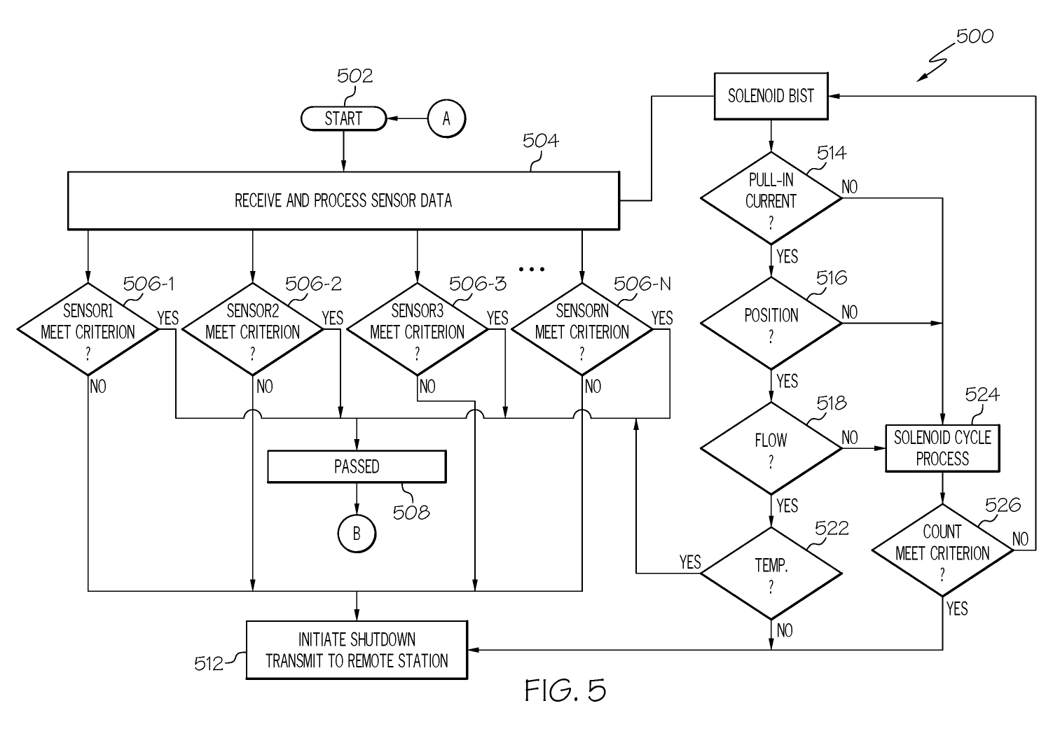

The control 214 may also be configured to implement numerous other functions. For example, the control 214 is also preferably configured to implement built-in self-tests of one or more of the solenoid 202, the fluid sensors 204, the solenoid sensors 206, the display device 208, the communication module 212, and even itself. For example, each time the smart solenoid control system 108 is powered up, and/or periodically thereafter, the control 214 may perform self-tests to determine various control system parameters, such as pull-in current, coil resistance, flow calibration, pressure calibration, temperature calibration, just to name a few. These parameters may then be compared to control system parameters stored in memory (e.g., EEPROM) on-board the control 214. In the event one or more of the parameters is outside of a predefined limit, the data and a warning alert may be supplied to the communication module 212 for transmission to the remote station 404 and/or handheld device 404. If needed or desired, the control 214 could also command a shutdown until service personnel intervened. One example of a built-in self-test process that the control may implement is depicted in flowchart form in FIG. 5, and with reference thereto, will now be described.

The process 500 is initiated (502), for example, upon power up. As FIG. 5 also depicts, it may also be initiated, at a set periodicity, following an end-of-life (EOL) process, which will be described further below. In any case, as FIG. 5 depicts, the process 500 uses various sensors mounted in the various circuit modules described above (e.g., the display driver 209, the communication module 212, the control 214, the solenoid driver 408) to self-test these devices, and uses the various solenoid sensors 206 and one or more of the fluid sensors 204 to self-test the solenoid 202.

With quick reference back to FIG. 4, it is seen that each of the various circuit modules has one or more sensors 412 mounted on or in them. These sensors 412 are configured to sense various parameters associated with the circuit modules. Some non-limiting examples of the sensed parameters include power up, circuit faults, illegal logic states, and memory faults, just to name a few. It should be noted that for clarity only one sensor 412 is depicted as being associated with each circuit module. Thus, only five sensors 412 are depicted. It will be appreciated, however, that the system 108 may include N-number of sensors (e.g., 412-N)

Returning to FIG. 5, the process 500 receives appropriate sensor data from each of the sensors 412, 204, 206 (504). The process 500 then proceeds by determining if each of the measured values from the sensors 412 (e.g., 412-1 to 412-N) meets a predetermined criterion (e.g., is within a predetermined range, exceeds a predetermined value, or is less than a predetermined value) (506-1, 506-2, 506-3 . . . 506-N). If the associated criterion is met, then the built-in self-test has passed (508), and the process transitions to the below-described EOL process. If the associated criterion is not met, then the built-in self-test has failed and a system shutdown is initiated, and the communication module 212 transmits an alarm to the remote station 402 (512).

The built-in self-test for the solenoid 202 determines if the measured values from one or more of the fluid sensors 204 and solenoid sensors 206 meets a predetermined criterion. For example, at least in the depicted embodiment, the process first determines if the solenoid pull-in current is in range (514). If so, the process then determines if the position of the solenoid is properly changed (516) and, if so, if the measured fluid flow is in within a predetermined range (518). If the measure fluid flow is within the predetermined range, the process then determines if the measured coil temperature is within the predetermined range (522). If so, then the built-in self-test has passed (508), and the process transitions to the below-described EOL process. If not, then the built-in self-test has failed and a system shutdown is initiated, and the communication module 212 transmits an alarm to the remote station 402 (512).

As FIG. 5 also depicts if any of the solenoid pull-in current, the solenoid position, or the measured fluid flow tests fail, then the process initiates a solenoid cycling process (524), during which the solenoid 202 is commanded to cycle a number of times, and this number is counted and stored. The cycle count is then compared to a predetermined count number (526). If it exceeds the predetermined count number, a system shutdown is initiated, and the communication module 212 transmits an alarm to the remote station 402 (512). If it does not exceed the predetermined count number, then the solenoid built-in self-test is reinitiated.

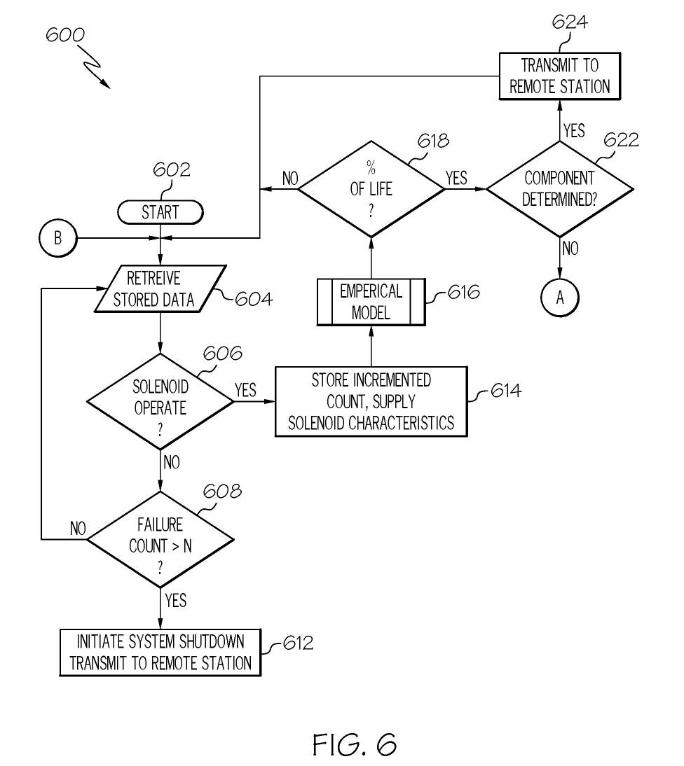

The control 214 is also preferably configured to prognosticate end-of-life (EOL) capabilities of one or more of the solenoid 202, the fluid sensors 204, the solenoid sensors 206, the display device 208, the communication module 212, and even itself. For example, the control 214 may track the endurance cycles completed and available, the total active hours of operation, the life of the solenoid 202, the fluid sensors 204, the solenoid sensors 206, the display device 208, the communication module 212, and even itself, faulted operations, just to name a few parameters. The control 214 may then generate and transmit EOL capabilities data to the communication module 212 for transmission to the remote station 402 and/or hand-held device 404. One example of an EOL process that the control may implement is depicted in flowchart form in FIG. 6, and with reference thereto, will now be described.

The process 600 is initiated (602), for example, upon power up. As FIG. 6 also depicts, it may also be initiated, at a set periodicity, following the above-described built-in self-test process 500. Regardless, as FIG. 6 depicts, the process 600, upon initiation, retrieves data stored in a database (604). The database may be implemented using memory on-board the control 214, one of the other circuit modules, or it may be implemented separate from the system 108. No matter where the database is physically located, it includes data representative of the mechanical and/or electrical endurance of various system devices. Some non-limiting examples include wiring mechanical and electrical endurance, solenoid mechanical endurance, position sensor mechanical and electrical endurance, and solenoid driver mechanical and electrical endurance, just to name a few.

No matter the specific mechanical and electrical endurance data, the process 600 then determines, based on the input from the solenoid position sensor 206-2 and from the solenoid driver 408, whether the solenoid 202 has operated properly (e.g., moved to the commanded position) (606). If not, then a failure count is incremented, and the failure count is compared to a predetermined number (608). If the failure count exceeds the predetermined number, then a system shutdown is initiated, and the communication module 212 transmits an alarm to the remote station 402 (612). If it does not exceed the predetermined number, then the EOL process 600 is reinitiated.

If, on the other hand, the solenoid 202 has operated properly (e.g., moved to the commanded position) (606), then an operational cycle count is incremented and stored, and various solenoid characteristics are retrieved (614). The solenoid operational characteristics that are retrieved may vary, but in one embodiment include, but are not limited to, drive current, temperature, total accumulated endurance hours of operation. These values are supplied to an empirical model that calculates the remaining useful life of each of the system components (616). It will be appreciated that anyone of numerous known empirical models may be implemented in the control 214 for making this calculation. A determination is then made as to whether the calculated remaining useful life indicates that one or more system components has reached a predetermined percentage of its life expectancy (618). It will be appreciated that the predetermined percentage may vary. In one particular embodiment, 80% is used.

If no component is determined to have reached predetermined percentage of its life expectancy, then the process 600 may repeat. Conversely, if it is determined that one or more system components may have reached the predetermined percentage of its life expectancy, then the process determines which of the components (e.g., solenoid coil, solenoid actuator, a solenoid sensor, a fluid sensor, the solenoid driver, the display driver, a fluid sensor, a circuit module sensor, etc.) this may be (622). Upon determining that a particular component has reached the predetermined percentage of its life expectancy, the communication module 212 transmits this information to the remote station 402 (624). If no particular component has reached the predetermined percentage of its life expectancy, the process transitions to the above-described built-in self-test process 500.

It will be appreciated that the control 214 may be configured to schedule Smart solenoid can be configured to schedule system 108 maintenance. To do so, the control 214 may interface with maintenance tools or centralized maintenance software stored, for example, in on-board memory. Alternatively, it may interface with the maintenance tools or centralized maintenance software stored in the remote station 402 or handheld device 404.

The control 214 may also be configured to track various alarms, if or when these occur. Such alarms may vary, but may include, for example, intruder alarms, leak alarms, over-pressure alarms, over-temperature alarms, and various hazard alarms, such as fire, smoke, leak, earthquake, floods, and physical damage (e.g. display panel tempering). Thus, as FIG. 4 also depicts, the system 108 may additionally include various other sensors such as, for example, an accelerometer 204-4 to detect intrusion and/or seismic events, and a carbon dioxide sensor 204-5 to detect smoke.

It was previously noted that the communication module 212 may also be configured to implement numerous other functions. For example, in some embodiments, the communication module 212 is further configured to receive solenoid control commands from the remote station 402 or handheld device 404 and, upon receipt thereof, supply the solenoid control commands to the control 214. The control 214, upon receipt of the commands, would command the solenoid 202 to move to the commanded (e.g., first or second) position. In some embodiments, the communication module 212 is further configured to receive solenoid control system settings from the remote station 402 or handheld device 404 and, upon receipt thereof, supply the solenoid control system settings to the control 214. In some embodiments, the communication module 212 is further configured to communicate with other devices, such as pumps and valves, associated with the conduit 102. Moreover, if one or more of these other devices becomes faulty, the control 214 can further implement the functions of a master controller.

The control 214 may also be configured to store various system, device, health, and prognostic data. The control 214, in response to one or more requests from, for example, the remote station 402 and/or handheld device 404, may transmit all or portions of the stored data. Alternatively, the control 214 may be configured to automatically transmit all or portions of the stored data automatically upon connection of the handheld device 404 (wired or wirelessly) to the system 108.

The smart solenoid control system 108 described herein provides the capability to remotely monitor fluid and system parameters, such as fluid pressure, fluid flow, fluid temperature, solenoid temperature, solenoid position, and to automatically implement various self-tests, fault detection, fault alarm, and fault isolation/prevention procedures.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A smart solenoid control system for controlling flow of fluid in a conduit, comprising:
a solenoid coupled to receive a drive current and configured, in response thereto, to move between a first position and a second position;
a plurality of fluid sensors, each fluid sensor configured to sense a parameter associated with the fluid in the conduit and supply a fluid sensor signal representative thereof;
a plurality of solenoid sensors, each solenoid sensor configured to sense a parameter associated with the solenoid and supply a solenoid sensor signal representative thereof;
a display device coupled to receive display commands and configured, upon receipt thereof, to render images;
a communication module coupled to receive data and configured, upon receipt thereof, to transmit the received data to a remote station or handheld device; and
a control coupled to receive the fluid sensor signals and the solenoid sensor signals and configured, upon receipt thereof, to:
determine whether the solenoid should be in the first or second position,
based on the determination, selectively supply the drive current to the solenoid to cause the solenoid to move to the first or second position,
at least selectively command the display device to render images representative of one or more of the parameters associated with the fluid and the parameters associated with the solenoid, and
supply the data to the communication module for transmission thereby.

2. The smart solenoid control system of claim 1, wherein:
the communication module is further configured to receive solenoid control commands from the remote station or handheld device and, upon receipt thereof, supply the solenoid control commands to the control; and
the control is further configured, upon receipt of the solenoid control commands, to supply the drive current to the solenoid to cause the solenoid to move to one of the first position or the second position.

3. The smart solenoid control system of claim 2, wherein the communication module is configured to wirelessly receive the solenoid control commands from the remote station or handheld device.

4. The smart solenoid control system of claim 2, wherein the communication module is configured to receive the solenoid control commands from the remote station or handheld device via a wired connection.

5. The smart solenoid of claim 2, wherein:
the communication module is further configured to receive solenoid control system settings from the remote station or handheld device and, upon receipt thereof, supply the solenoid control system settings to the control; and
the control is further configured, upon receipt of the solenoid control system settings, to update operational settings of the system.

6. The smart solenoid control system of claim 1, wherein the display device is a touchscreen display device.

7. The smart solenoid control system of claim 1, wherein the communication module is further configured to:
communicate with other devices associated with the conduit; and
in the event one or more of the other devices is faulty, to act as a master controller.

8. The smart solenoid control system of claim 1, wherein the control is further configured to:
implement built-in self-tests of one or more of itself, the solenoid, the fluid sensors, the solenoid sensors, the display device, and the communication module; and
prognosticate end-of-life capabilities of one or more of itself, the solenoid, the fluid sensors, the solenoid sensors, the display device, and the communication module.

9. The smart solenoid system of claim 8, wherein the control is further configured to schedule when the built-in self-tests and end-of-life prognostications occur.

10. The smart solenoid system of claim 1, wherein:
the handheld device comprises one of a smartphone or a tablet; and
the handheld device implements a downloadable application associated with the smart solenoid system.

11. The smart solenoid control system of claim 1, wherein the control is further configured to:
at least selectively store at least portions of the data; and
selectively command the communication module to transmit all or portions of the stored data.

12. The smart solenoid control system of claim 1, wherein:
the fluid sensors include one or more of a fluid pressure sensor, a fluid temperature sensor, and a fluid flow sensor; and
the solenoid sensors include one or more of solenoid current sensor, a solenoid position sensor, and a solenoid temperature sensor.

13. The smart solenoid control system of claim 12, further comprising:
an accelerometer; and
a carbon dioxide sensor.

14. A smart solenoid control system for controlling flow of fluid in a conduit, comprising:
a solenoid coupled to receive a drive current and configured, in response thereto, to move between a first position and a second position;
a plurality of fluid sensors, each fluid sensor configured to sense a parameter associated with the fluid in the conduit and supply a fluid sensor signal representative thereof;
a plurality of solenoid sensors, each solenoid sensor configured to sense a parameter associated with the solenoid and supply a solenoid sensor signal representative thereof;
a display device coupled to receive display commands and configured, upon receipt thereof, to render images;
a communication module configured to receive solenoid control system settings from a remote station or handheld device and, upon receipt thereof, to supply the solenoid control system settings; and
a control coupled to receive the fluid sensor signals, the solenoid sensor signals, and the solenoid control system settings, the control configured, upon receipt thereof to:
determine whether the solenoid should be in the first or second position,
based on the determination, selectively supply the drive current to the solenoid to cause the solenoid to move to the first or second position,
at least selectively command the display device to render images representative of one or more of the parameters associated with the fluid and the parameters associated with the solenoid,
implement built-in self-tests of one or more of itself, the solenoid, the fluid sensors, the solenoid sensors, the display device, and the communication module, and
prognosticate end-of-life capabilities of one or more of itself, the solenoid, the fluid sensors, the solenoid sensors, the display device, and the communication module.

15. The smart solenoid control system of claim 14, wherein:
the communication module is further configured to receive solenoid control commands from the remote station or handheld device and, upon receipt thereof, supply the solenoid control commands to the control; and
the control is further configured, upon receipt of the solenoid control commands, to supply the drive current to the solenoid to cause the solenoid to move to one of the first position or the second position.

16. The smart solenoid control system of claim 15, wherein the communication module is configured to wirelessly receive the solenoid control commands from the remote station or handheld device.

17. The smart solenoid control system of claim 15, wherein the communication module is configured to receive the solenoid control commands from the remote station or handheld device via a wired connection.

18. The smart solenoid control system of claim 14, wherein the display device is a touchscreen display device.

19. The smart solenoid control system of claim 14, wherein the communication module is further configured to communicate with other devices associated with the conduit.

20. A smart solenoid control system for controlling flow of fluid in a conduit, comprising:
an explosion-proof enclosure;
a solenoid disposed within the explosion-proof enclosure, the solenoid coupled to receive a drive current and configured, in response thereto, to move between a first position and a second position;
a plurality of fluid sensors disposed within the explosion-proof enclosure, each fluid sensor configured to sense a parameter associated with the fluid in the conduit and supply a fluid sensor signal representative thereof;
a plurality of solenoid sensors disposed within the explosion-proof enclosure, each solenoid sensor configured to sense a parameter associated with the solenoid and supply a solenoid sensor signal representative thereof;
a touchscreen display device disposed within the explosion-proof enclosure, the touchscreen display device coupled to receive display commands and configured, upon receipt thereof, to render images;
a communication module disposed within the explosion-proof enclosure, the communication module coupled to receive data and configured, upon receipt thereof, to transmit the received data to a remote station or handheld device; and
a control disposed within the explosion-proof enclosure, the control coupled to receive the fluid sensor signals and the solenoid sensor signals and configured, upon receipt thereof, to:
determine whether the solenoid should be in the first or second position,
based on the determination, selectively supply the drive current to the solenoid to cause the solenoid to move to the first or second position,
at least selectively command the display device to render images representative of one or more of the parameters associated with the fluid and the parameters associated with the solenoid, and
supply the data to the communication module for transmission thereby.
